(19) United States
(12) Patent Application Publication
(10) Pub. No.: US 2026/0064610 A1
(43) Pub. Date: Mar. 5, 2026

(54) ADDRESS VALIDATION IN PEER-TO-PEER COMMUNICATION BETWEEN I/O DEVICES OF A COMPUTER

(71) Applicant: INTERNATIONAL BUSINESS MACHINES CORPORATION, ARMONK, NY (US)

(72) Inventors: APOORVE MOHAN, White Plains, NY (US); Christoph Raisch, Gerlingen (DE); Marco Kraemer, Sindelfingen (DE); Marcel Schaal, Fort Montgomery, NY (US); Hubertus Franke, Cortlandt Manor, NY (US)

(21) Appl. No.: 18/824,844

(22) Filed: Sep. 4, 2024

(51) Int. Cl. G06F 13/20

(52) U.S. Cl. CPC G06F 13/20; G06F 2213/40

(57) ABSTRACT

Address validation for peer-to-peer communication among a plurality of I/O devices via an interconnect includes identifying a number of isolation groups within a virtual partitioning of address space of the I/O devices; and storing address filters at locations associated with the plurality of I/O devices. Let N be the number of isolation groups, and i be an index from 1 to N. Each isolation group includes a subset of the plurality of I/O devices. The address filter associated with an I/O device of an i^{th} isolation group includes identifications and address ranges of other I/O devices of the i^{th} isolation group so as to authorize read and write operations on peer address space of the i^{th} isolation group.

### BACKGROUND

### Technical Field

The present disclosure generally relates to a computer including input/output (I/O) devices that communicate over an interconnect, and more particularly, to address validation in peer-to-peer communication between such I/O devices.

### Description of the Related Art

Traditionally, peer-to-peer (P2P) communication between I/O devices in a computer has been routed through a central processing unit (CPU). The CPU performs address validation and steers the P2P communication between the I/O devices.

Protocols have emerged to allow direct P2P communication without address validation through the CPU. For instance, Address Translation Services (ATS) caches validated direct memory access (DMA) addresses in the I/O devices for trusted P2P DMA. Each I/O device maintains the cached addresses in an address translation cache (ATC).

Consider the example of P2P communication between endpoint devices connected to a Peripheral Component Interconnect Express (PCIe) interconnect. If an endpoint device receives a DMA request whose address corresponds to a cached address translation in the ATC, the request is validated. However, for every new DMA request that is not cached in the ATC, the DMA request is forwarded to a root complex of the PCIe interconnect for validation.

### SUMMARY

According to an embodiment of the present disclosure, a computer-implemented method of address validation for peer-to-peer communication among a plurality of I/O devices via an interconnect includes identifying a number of isolation groups within a virtual partitioning of address space of the I/O devices; and storing address filters at locations associated with the plurality of I/O devices. Let N be the number of isolation groups, and let i be an index from 1 to N. Each isolation group includes a subset of the plurality of I/O devices. An address filter associated with an I/O device of an i^{th} isolation group includes identifications and address ranges of other I/O devices of the i^{th} isolation group so as to authorize read and write operations on peer address space of the i^{th} isolation group.

In some embodiments, at least some of the address filters are stored in memory of their associated I/O devices. In other embodiments, the address filters may be stored in switch ports to which their associated I/O devices are connected.

In some embodiments, the method further includes performing the partitioning of the address space, including setting up partitions. The isolation groups are identified and the address filters are stored after the partitions have been set up.

In some embodiments, the identifying and the storing are performed by a computer including an input/output memory management unit (IOMMU). The isolation groups are identified by examining the IOMMU.

In some embodiments, the method further includes using the address filters to perform address validation to prevent unauthorized access. Before a given I/O device issues a DMA request, the address filter associated with the given I/O device is accessed. A determination is made as to whether information in the DMA request matches an entry in the accessed address filter; the DMA request is dropped if there is no match. The DMA request is issued if there is a match.

In some embodiments, the interconnect is a PCIe interconnect. The address validation for each DMA request is performed without accessing a root complex of the PCIe interconnect.

In some embodiments, the method further includes updating the address filters associated with the i^{th} isolation group to reflect device changes in the i^{th} isolation group.

According to an embodiment of the present disclosure, a computer includes an interconnect; a plurality of I/O devices connected to the interconnect; a memory having computer readable instructions; and a processor set, connected to the interconnect, for executing the computer readable instructions to configure the computer to set up address validation for peer-to-peer communication between the I/O devices. Setting up the address validation includes identifying a number of isolation groups within a virtual partitioning of an address space across the plurality of I/O devices; and storing address filters at locations associated with the plurality of I/O device. An address filter associated with an I/O device of a given isolation group includes identifications and address ranges of other I/O devices of the given isolation group so that the I/O devices of the given isolation group are authorized to read and write on peer address space.

In some embodiments, the address filters are stored in their associated I/O devices. Each I/O device includes a core configured to use its associated address filter to perform address validation to prevent unauthorized access upon receipt of a DMA request. This includes making a determination as to whether a remote address in the DMA request matches an entry in the associated address filter; dropping the DMA request if there is no match; and issuing the DMA request if there is a match.

In some embodiments, the interconnect includes a switch, at least some of the I/O devices are connected to ports of the switch, and the address filters are stored in the ports to which their associated I/O devices are connected. The switch includes a controller configured to perform address validation to prevent unauthorized access upon receipt of a DMA request, including accessing the address filter from the port to which a destination I/O device is connected; using the accessed address filter to make a determination as to whether a user ID and remote address in the DMA request matches an entry in the accessed address filter; dropping the DMA request if there is no match; and issuing the DMA request if there is a match.

In some embodiments, identifying the number of isolation groups includes examining an input/output memory management unit of the computer.

In some embodiments of the computer, the interconnect is a PCIe interconnect, and the address validation is performed without accessing a root complex of the PCIe interconnect.

According to an embodiment of the present disclosure, a computer program product includes one or more computer-readable memory devices encoded with data including instructions that, when executed, causes a processor set to perform an address validation method for peer-to-peer communication between a plurality of I/O devices connected to a computer interconnect. The method includes identifying a number of isolation groups within a virtual partitioning of an address space across the plurality of I/O devices; and storing address filters associated with the plurality of I/O devices. An address filter associated with an I/O device of a given isolation group includes identifications and address ranges of any other I/O devices of the given isolation group so that no I/O devices outside of the given isolation group are authorized to perform DMA operations on peer address space of the given isolation group.

In some embodiments, the address filters are stored in their associated I/O devices. In other embodiments, the address filters can be stored in switch ports to which their associated I/O devices are connected.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a computing environment, consistent with an illustrative embodiment.

FIG. 2 is a computer including a PCIe interconnect, consistent with an illustrative embodiment.

FIG. 3 is a computer-implemented method of address validation, consistent with an illustrative embodiment.

FIG. 4 is a computer-implemented method of handling a DMA request, consistent with an illustrative embodiment.

FIG. 5 is an illustration of a peer-to-peer communication, consistent with an illustrative embodiment.

FIG. 6 is an illustration of a peer-to-peer communication, consistent with an illustrative embodiment.

FIG. 7 is an address filter, consistent with an illustrative embodiment.

### DETAILED DESCRIPTION

### Overview and Support

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to address validation in peer-to-peer communications between I/O devices in a computer. By virtue of the concepts discussed herein, address validation is performed more efficiently than ATS, and certain limitations of ATS are avoided.

According to an embodiment of the present disclosure, a computer-implemented method of address validation for peer-to-peer communication among a plurality of I/O devices via an interconnect includes identifying a number of isolation groups within a virtual partitioning of address space of the I/O devices; and storing address filters at locations associated with the plurality of I/O devices. Let N be the number of isolation groups, and let i be an index from 1 to N. Each isolation group includes a subset of the plurality of I/O devices. The address filter associated with an I/O device of an i^{th} isolation group includes identifications and address ranges of other I/O devices of the i^{th} isolation group so as to authorize read and write operations on peer address space of the i^{th} isolation group.

The method avoids routing P2P communications through a CPU, yet still provides address validation to prevent unauthorized access to I/O device resources. The method also avoids the use of address translation caches. Advantageously, address filters are created after virtual partitioning of address space of the I/O devices and do not change unless the address space is modified. Computer resources are not spent building address translation caches on demand during P2P communications. Computer resources are not spent maintaining address translation caches, which tend to be power-hungry.

The method can be more efficient than ATS. Address validation is performed without involving the root complex. A replacement policy is not required, whereas ATS follows a replacement policy for its address translation caches. Each entry of the address filter may have a translated address range, which is not limited and expresses a wide range of an address space, whereas entries in the address translation caches cover a small number of translated addresses, which can result in performance bottlenecks.

In some embodiments, which can be combined with the previous embodiment, at least some of the address filters are stored in memory of their associated I/O devices. If, however, the interconnect includes a switch, and at least some of the I/O devices are connected to ports of the switch, then at least some of the address filters may be stored in the ports to which their associated I/O devices are connected. Having the address filters in the switch advantageously removes the dependency from I/O device vendors to implement the address filters.

In some embodiments, which can be combined with one or more of the previous embodiments, the method further includes performing the partitioning of the address space, including setting up partitions; wherein the isolation groups are identified and the address filters are stored after the partitions have been set up. Advantageously, the address filters are not constructed or maintained during P2P communications.

In some embodiments, which can be combined with one or more of the previous embodiments, the identifying and the storing are performed by a computer including the interconnect, the I/O devices, and also an input/output memory management unit (IOMMU). The isolation groups are identified by examining the IOMMU.

In some embodiments, which can be combined with one or more of the previous embodiments, the method further includes using the address filters to perform address validation to prevent unauthorized access. Before a given I/O device issues a DMA request, the address filter associated with the given I/O device is accessed; and a determination is made as to whether information in the DMA request matches an entry in the accessed address filter. The DMA request is dropped if there is no match; and the DMA request is issued if there is a match. In this manner, address validation is performed without the use of address translation caches.

The method may be advantageously implemented in a computer where the interconnect is a PCIe interconnect. The address validation for each DMA request is performed without accessing a root complex of the PCIe interconnect.

In some embodiments, which can be combined with one or more of the previous embodiments, filtering granularity is substantially greater than 4 KB. In contrast, ATC coverage is limited by its number of entries and also maximum read rate of the interconnect (4 KB for PCIe). As a result, the addressability to remote devices results in frequent revalidation of the ATC entries. This contributes to the significant performance overhead.

In some embodiments, which can be combined with one or more of the previous embodiments, the method further includes updating the address filters associated with the i^{th} isolation group to reflect device changes in the i^{th} isolation group. As a result, consistency is maintained between the address filters and the isolation groups.

According to an embodiment of the present disclosure, a computer includes an interconnect; a plurality of I/O devices connected to the interconnect; a memory having computer readable instructions; and a processor set, connected to the interconnect, for executing the computer readable instructions to configure the computer to set up address validation for peer-to-peer communication between the I/O devices. Setting up the address validation includes identifying a number of isolation groups within a virtual partitioning of an address space across the plurality of I/O devices; and storing address filters at locations associated with the plurality of I/O devices. An address filter associated with an I/O device of a given isolation group includes identifications and address ranges of other I/O devices of the given isolation group so that the I/O devices of the given isolation group are authorized to read and write on peer address space.

The computer avoids routing P2P communications through a CPU, yet still provides address validation to prevent unauthorized access to I/O device resources. The computer also avoids the use of address translation caches. Advantageously, address filters are created after virtual partitioning of address space of the I/O devices and do not change unless the address space is modified. Computer resources are not spent building address translation caches on demand during P2P communications. Computer resources are not spent maintaining address translation caches, which tend to be power-hungry.

The use of address filters can be more efficient than ATS. Address validation is performed without involving the root complex. A replacement policy is not required, whereas ATS follows a replacement policy for its address translation caches. Each entry of the address filter may have a translated address range, which is not limited and expresses a wide range of an address space, whereas entries in the address translation caches cover a small number of translated addresses, which can result in performance bottlenecks.

In some embodiments, which can be combined with the previous embodiment, the address filters are stored in their associated I/O devices.

In some embodiments, which can be combined with one or more of the previous embodiments, each I/O device includes a core configured to use its associated address filter to perform address validation to prevent unauthorized access upon receipt of a DMA request. A determination is made as to whether a remote address in the DMA request matches an entry in the associated address filter. The DMA request is dropped if there is no match, and it is issued if there is a match.

In some embodiments, which can be combined with one or more of the previous embodiments, the interconnect includes a switch. At least some of the I/O devices are connected to ports of the switch, and the address filters are stored in the ports to which their associated I/O devices are connected. Having the address filters in the switch advantageously removes the dependency from I/O device vendors to implement the address filters.

In some embodiments, which can be combined with one or more of the previous embodiments, the switch includes a controller configured to perform address validation to prevent unauthorized access upon receipt of a DMA request, including accessing the address filter from the port to which a destination I/O device is connected; using the accessed address filter to make a determination as to whether a user ID and remote address in the DMA request matches an entry in the accessed address filter; dropping the DMA request if there is no match; and issuing the DMA request if there is a match.

In some embodiments, which can be combined with one or more of the previous embodiments, identifying the number of isolation groups includes examining an input/output memory management unit.

In some embodiments, which can be combined with one or more of the previous embodiments, the interconnect is a PCIe interconnect, and the address validation is performed without accessing a root complex of the PCIe interconnect.

According to an embodiment of the present disclosure, a computer program product includes one or more computer-readable memory devices encoded with data including instructions that, when executed, causes a processor set to perform an address validation method for peer-to-peer communication between a plurality of I/O devices connected to a computer interconnect. The address validation method includes identifying a number of isolation groups within a virtual partitioning of an address space across the plurality of I/O devices; and storing address filters associated with the plurality of I/O devices. An address filter associated with an I/O device of a given isolation group includes identifications and address ranges of any other I/O devices of the given isolation group so that no I/O devices outside of the given isolation group are authorized to perform DMA operations on peer address space of the given isolation group.

In some embodiments, which can be combined with the previous embodiment, the address filters are stored in their associated I/O devices, or the address filters are stored in switch ports to which their associated I/O devices are connected. Having the address filters in the switch advantageously removes the dependency from I/O device vendors to implement the address filters.

The address validation method avoids routing P2P communications through a CPU, yet still provides address validation to prevent unauthorized access to I/O device resources. The use of address translation caches is also avoided. Advantageously, address filters are created after virtual partitioning of address space of the I/O devices and do not change unless the address space is modified. Computer resources are not spent building address translation caches on demand during P2P communications. Computer resources are not spent maintaining address translation caches, which tend to be power-hungry.

The address validation method can be more efficient than ATS. Address validation is performed without involving the root complex. A replacement policy is not required, whereas ATS follows a replacement policy for its address translation caches. Each entry of the address filter may have a translated address range, which is not limited and expresses a wide range of an address space, whereas entries in the address translation caches cover a small number of translated addresses, which can result in performance bottlenecks.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

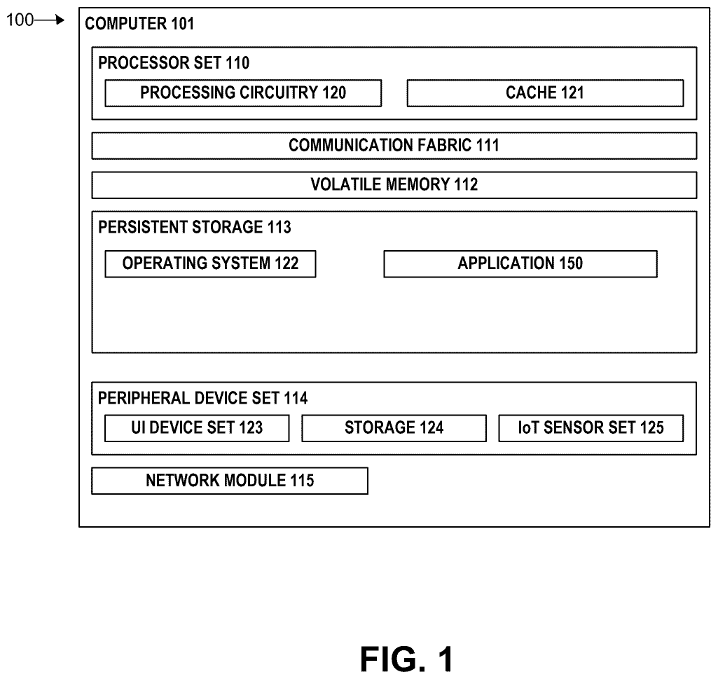

Reference is made to FIG. 1. A computing environment 100 includes an example of an environment for the execution of at least some of the computer code involved in performing the inventive methods. The computing environment 100 includes, for example, computer 101. The computing environment 100 may also include other features, such as a wide area network, end user device, remote server, public cloud, and private cloud (not shown). In this embodiment, the computer 101 includes processor set 110, communication fabric 111, volatile memory 112, persistent storage 113 (including operating system 122 and application 150), peripheral device set 114 (including user interface (UI) device set 123, storage 124, Internet of Things (IoT) sensor set 125), and network module 115.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

At least some of the instructions for performing the inventive methods may be stored in persistent storage 113 as part of the operating system 122 or an application 150 that is privileged. Such an operating system 122 or application 150 sets up address filters for address validation for peer-to-peer communication among a plurality of I/O devices via an interconnect.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 301 to communicate with other computers through a network. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

### Example Computer

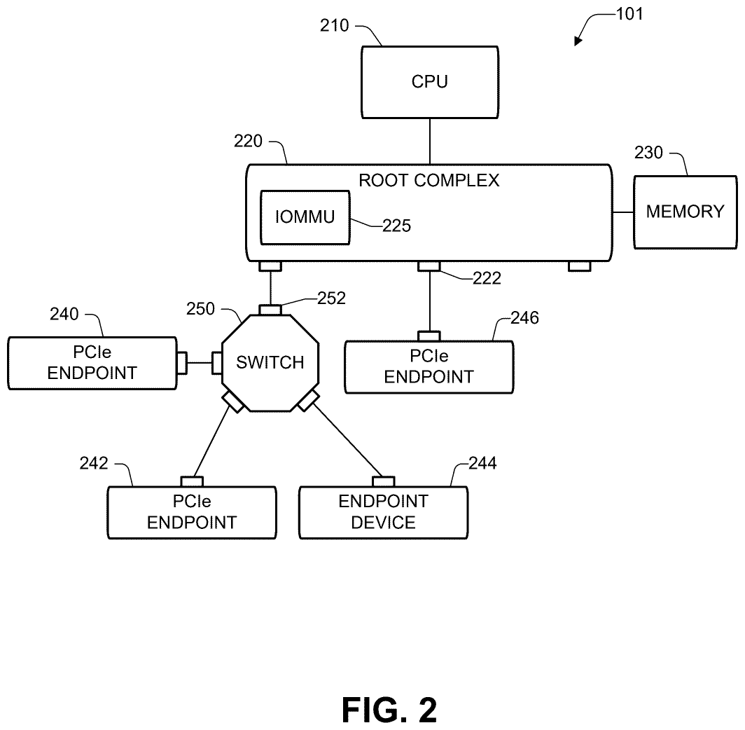

Reference is made to FIG. 2, which illustrates an example of a computer 101 in which the processor set 110 includes a CPU 210, and the communication fabric 111 includes a PCIe interconnect. The PCIe interconnect includes root complex 220, which is connected to the CPU 210 and system memory 230. The root complex 220 provides an interface between the CPU 210 and the system memory 230 and a plurality of endpoint devices 240-246. The root complex 220 is responsible for data transfer with the CPU 210, and it is responsible for ensuring that data is routed correctly between the endpoint devices 240-246. In the example of FIG. 2, endpoint device 246 is connected directly to a port 222 of the root complex 220. Endpoint devices 240, 242 and 244 are connected to ports 252 of a switch 250, and the switch 250 is connected to another port 222 of the root complex 220. Four endpoint devices 240-246 are shown as an example.

The endpoint devices 240-246 may include components of the processor set 110, persistent storage 113, and the network module 115. Examples of endpoint devices from the processor set 110 may include a graphics processing unit (GPU), a tensor processing unit (TPU) and an accelerator. Examples of endpoint devices from the persistent storage 113 may include a non-volatile memory express (NVMe) drive and a solid-state drive (SSD). An example of an endpoint device from the network module 115 is a network interface card. In general, each endpoint device 240-246 includes addressable memory and a core (e.g., a controller).

The PCIe interconnect may include an input/output memory management unit (IOMMU) 225, which may be integrated with the root complex 220. The IOMMU 225 translates CPU-visible virtual addresses to physical address. The IOMMU also translates device addresses (that is, device-visible virtual addresses) to physical addresses.

On virtualization systems, the IOMMU 225 also facilitates device isolation and the IOMMU's controller may choose to place I/O devices in different IOMMU groups for protection reasons at the host level. IOMMU groups are assigned by the IOMMU controller and maintained as a data structure in the operating system 122.

These IOMMU groups are referred to herein by the more general term “isolation groups.” In general, an isolation group refers to a group of I/O devices, either physical or virtual, that are authorized to communicate with each other (“peers”). As used herein, “peer address space” refers to the address space of an I/O device in an isolation group. Thus, PCI address space is also organized into isolation groups and their corresponding peer address spaces.

### Example Methods

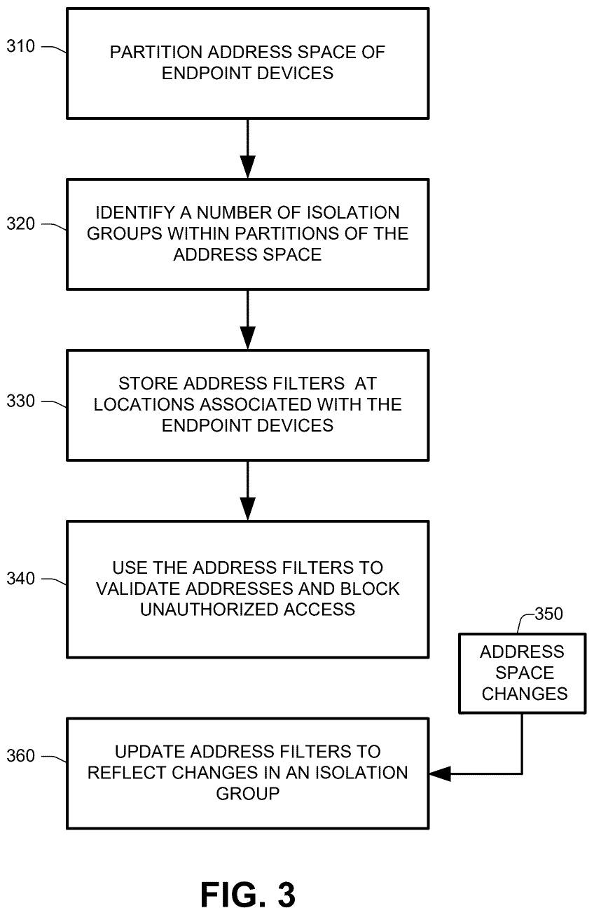

Additional reference is made to FIG. 3, which illustrates a computer-implemented method for setting up address filters for address validation for peer-to-peer communication among I/O devices in the computer 101 of FIG. 2. Thus, FIG. 3 will refer to the interconnect as a PCIe interconnect, and it will refer to the I/O devices as endpoint devices 240-246. The method may be performed by the operating system 122 or the application 150.

At block 310, a partitioning of the address space of the endpoint devices 240-246 is performed. The partitioning may be performed by the operating system 122 at bootup of the computer 101 when the endpoint devices 240-246 are identified.

At block 320, a number of isolation groups are identified within a virtual partitioning of the address space of the endpoint devices 240-246. The isolation groups may be identified by examining the IOMMU 225. Initial population of IOMMU groups may be based on a physical layout of the components of the computer 101.

Each endpoint device 240-246 is a member of at least one isolation group. Consider an example in which endpoint devices 240 and 242 are members of a first isolation group, and endpoint devices 244 and 246 are members of a second isolation group. In this example, endpoint devices 240 and 242 are authorized to perform DMA operations on peer address space of the first isolation group. Endpoint devices 244 and 246 are authorized to perform DMA operations on peer address space of the second isolation group. The endpoint devices 240 and 242 of the first isolation group are not authorized to perform DMA operations on peer address space of the second isolation group. The endpoint devices 244 and 246 of the second isolation group are not authorized to perform DMA operations on peer address space of the first isolation group.

At block 330, address filters are stored at locations associated with the endpoint devices 240-246. An address filter is a data structure (e.g., a table or list) that includes identifications and address ranges of endpoint devices in the same isolation group. A choice of the locations include the endpoint devices 240-246 and the switch ports 252 to which the endpoint devices 240-246 are connected.

Let N be the number of isolation groups, and let i be an index from 1 to N. Each isolation group includes a subset of the endpoint devices 240-246. The address filter associated with an I/O device of an i^{th} isolation group includes identifications and address ranges of other I/O devices of the i^{th} isolation group so as to authorize read and write operations on peer address space of the i^{th} isolation group.

Further considering the example above of the two isolation groups, an address filter associated with endpoint device 240 includes the ID and address range of the endpoint device 242, but not the endpoint devices 244 and 246. An address filter associated with the endpoint device 244 includes the ID and address range of the endpoint device 246, but not the endpoint devices 240 and 242.

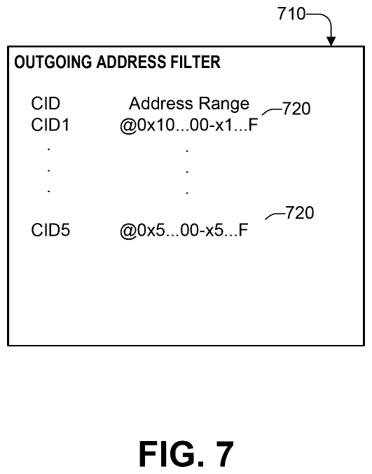

Reference is made to FIG. 7, which illustrates an example of an outgoing address filter 710 that is stored in a port 252 of the switch 250. Each filter entry 720 of the outgoing address filter 710 includes a context identification (CID) and an address range within the associated physical device. A filter entry 720 may represent the entire physical device and its entire address range, or it may represent a physical device and a subset of the entire address range. An example of a CID in a PCIe-based system is a PCIe device address of a virtual function or the entire device on the PCIe interconnect. Other examples include mappings between users and device-maintained identifications.

Each entry 720 in the address filter 710 has a filtering granularity based on an address range. This enables filtering granularity to be significantly greater than 4 KB. The significantly greater filtering granularity avoids overhead issues for large data transfers, which issues are present in ATS.

The caches in ATS, in contrast, have a filtering granularity of 4 KB. The maximum number of ATC entries is limited, and PCIe maximum read request (MRR) is 4 KB. For example, if the maximum number of entries is limited to 512, then ATC coverage is 512*4 KB=2M, which is too small for large data transfers. As a result of the small entry sizes and number of entries, the addressability to remote devices results in frequent revalidation of the cache entries. This contributes to the significant performance overhead in ATS.

Reference is once again made to FIG. 3. The method at block 340 further includes using the address filters for address validation to prevent unauthorized access. Address filters stored in the endpoint devices 240-246 are used by the endpoint devices for address validation. Address filters stored in the switch ports 252 are used by the switch 250 for address validation.

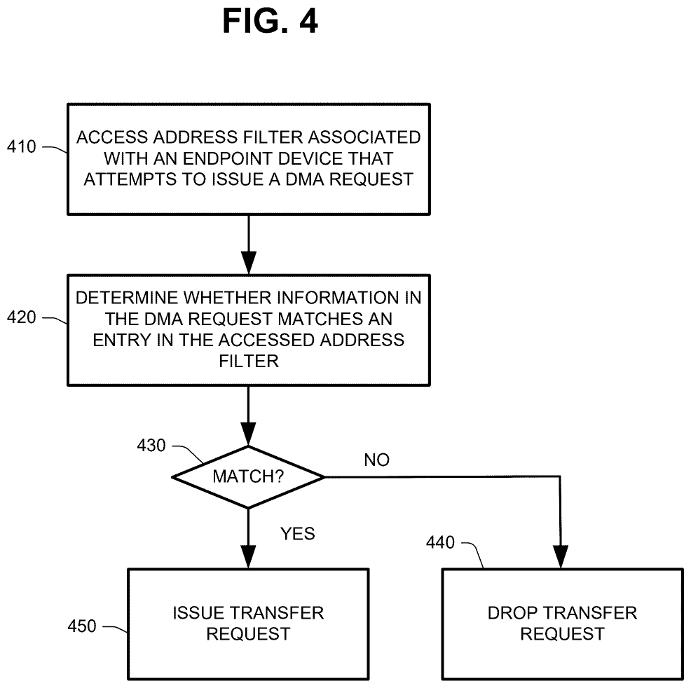

Additional reference is made to FIG. 4, which illustrates an example of using an outgoing address filter to validate addresses and block unauthorized access when an endpoint device attempts to issue a DMA request. The address filter associated with that endpoint device is accessed (block 410)

A determination is made information in the DMA request matches an entry in the accessed address filter (block 420). For an outgoing address filter stored in a port 252 of a switch 250, a determination is made as to whether a CID (e.g., switch port number of the issuing I/O device) and remote address in the DMA request matches an entry in the accessed address filter. For an outgoing address filter stored in an I/O device 240-246, a determination is made as to whether a CID and a remote address in the DMA request matches an entry in the accessed address filter.

The DMA request is dropped if there is no match (blocks 430 and 440). The DMA request is issued if there is a match (blocks 430 and 450).

The address filters are not updated unless the interconnect address space is modified. The isolation groups identified in the IOMMU 225 may be populated at the time of system boot up as the operating system 122 finds the endpoint devices 240-246. If the address space does not change, there is no need to update the address filters.

However, if the address space changes (block 350), at least some of the address filters are updated. For instance, the address space is changed if a hot plug device is added to, or removed from, the interconnect.

At block 360 the address filters associated with an isolation group are updated to reflect changes in that isolation group. If changes to the address space affect the address filters of other isolation groups, then the address filters of the other isolation groups are also updated. As a result, consistency is maintained between the address filters and the isolation groups, and security guarantees provided via the IOMMU isolation groups are not violated.

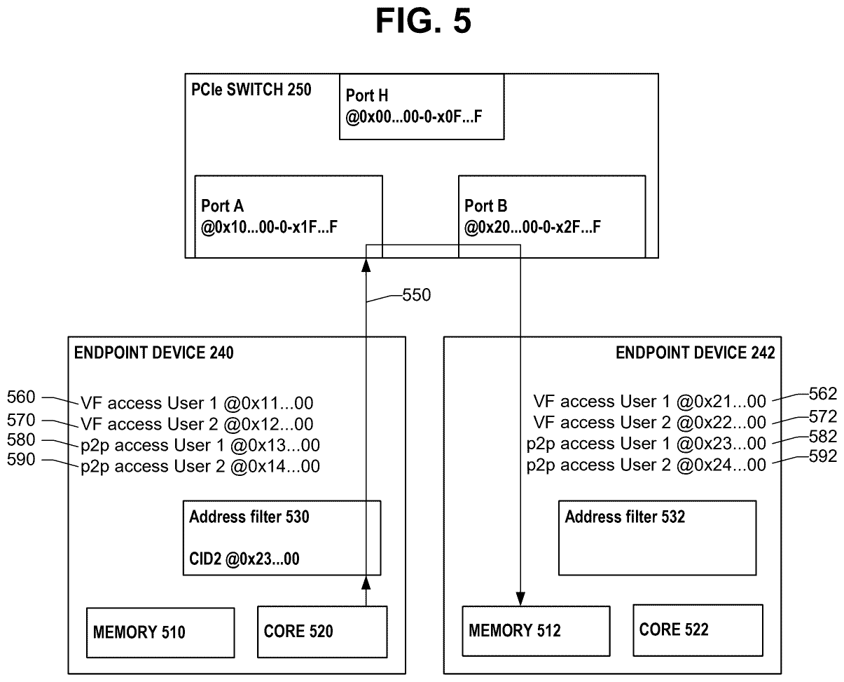

Reference is now made to FIG. 5, which illustrates an example of address filtering performed by endpoint devices 240 and 242. Endpoint device 240 includes memory 510 and a core 520. Endpoint device 242 includes memory 512 and a core 522. Address filters 530 and 532 are stored in the endpoint devices 240 and 242, respectively. The end point device 240 is shared across virtual functions 560 and 570 with their respective address ranges for non-P2P DMA operations. The end point device 242 is shared across virtual functions 562 and 572 with their respective address ranges for non-P2P DMA operations. The end point device 240 defines address ranges 580 and 590 for P2P DMA for virtual functions 560 and 570. The end point device 242 defines address ranges 582 and 592 for P2P DMA for virtual functions 562 and 572.

FIG. 5 also illustrates an example of a P2P DMA request 550 sent from virtual function 570 originating from address range 590 to address 592 of virtual function 562. The P2P DMA request includes a CID on endpoint device 240 and destination address on endpoint device 242. The CID associated to a DMA request represents the ownership of a DMA request at its source. If a source virtual function 570 on endpoint device 240 (or the entire source endpoint device) and a destination virtual function 562 on endpoint device 242 (or the entire destination endpoint device) are in the same isolation group, the CID associated with the source and the destination memory address 540 are found in the address filter table 530. If a match is found, the P2P DMA request is issued, and a DMA operation is performed on the memory 512 of the endpoint device 242. If no entry is found, the request 550 is blocked, or it is routed through the switch 250 to the endpoint device 242 based on PCIe address-based routing. In the example of FIG. 5, the request 550 is issued.

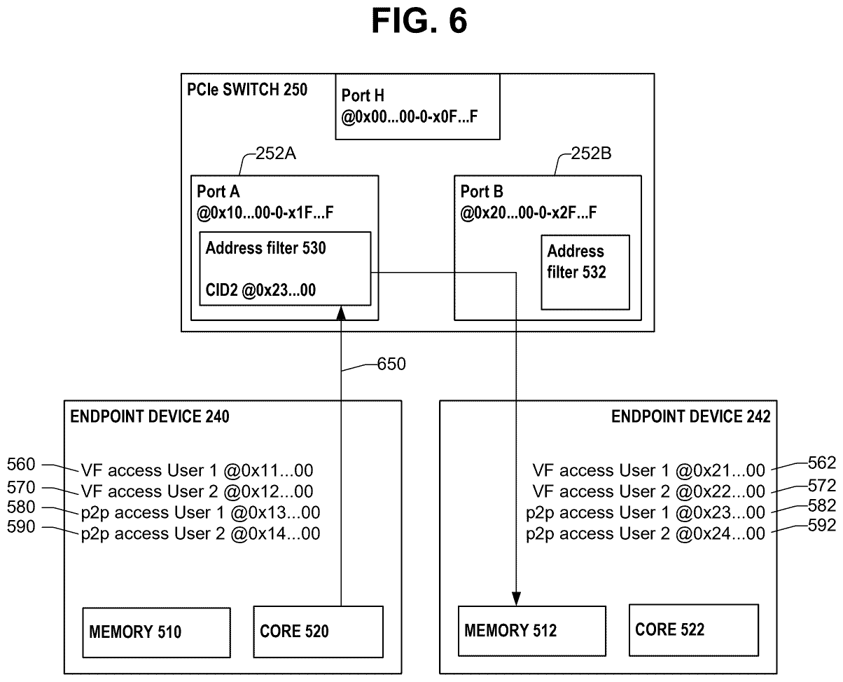

Reference is now made to FIG. 6, which illustrates address filters 530 and 532 stored in ports 252A and 252B, respectively, of the switch 250, and address filtering performed in the switch 250. FIG. 6 also illustrates a P2P DMA request 650 sent by endpoint device 240 to endpoint device 242. The P2P DMA request 650 includes a source CID on endpoint device 240 and a destination address on endpoint device 242. When the core 520 on endpoint device 240 issues the P2P DMA request 650, the request is validated at the address filter 530 based on the source and the destination memory address 540 present at the port 252A. If a source virtual function 570 on endpoint device 240 (or the entire source endpoint device) and a destination virtual function 562 on endpoint device 242 (or the entire destination endpoint device) are in the same isolation group, the CID associated with the source and the destination memory address 540 are found in the address filter table 530, whereby the request 650 is issued. If no entry is found, the request 650 is blocked or routed through the switch 250 to the endpoint device 242 based on PCIe address-based routing.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of address validation for peer-to-peer communication among a plurality of I/O devices via an interconnect, the method comprising:
identifying a number of isolation groups within a virtual partitioning of address space of the I/O devices; and
storing address filters at locations associated with the plurality of I/O devices;
wherein:
N is the number of isolation groups, and i is an index from 1 to N;
each isolation group includes a subset of the plurality of I/O devices; and
the address filter associated with an I/O device of an i^{th} isolation group includes identifications and address ranges of other I/O devices of the i^{th} isolation group so as to authorize read and write operations on peer address space of the i^{th} isolation group.

2. The method of claim 1, wherein at least some of the address filters are stored in memory of their associated I/O devices.

3. The method of claim 1, wherein:
the interconnect includes a switch;
at least some of the I/O devices are connected to ports of the switch; and
at least some of the address filters are stored in the ports of the switch to which their associated I/O devices are connected.

4. The method of claim 1, further comprising performing the partitioning of the address space, including setting up partitions; wherein the isolation groups are identified and the address filters are stored after the partitions have been set up.

5. The method of claim 1, wherein the identifying and the storing are performed by a computer including the interconnect and the I/O devices.

6. The method of claim 5, wherein the computer further includes an input/output memory management unit (IOMMU), and wherein the isolation groups are identified by examining the IOMMU.

7. The method of claim 1, further comprising:
using the address filters to perform address validation to prevent unauthorized access before a given I/O device issues a DMA request, comprising:
accessing the address filter associated with the given I/O device;
determining whether information in the DMA request matches an entry in the accessed address filter;
dropping the DMA request upon determining that there is no match; and
issuing the DMA request upon determining that there is a match.

8. The method of claim 7, wherein the interconnect is PCIe interconnect, and wherein the address validation for each DMA request is performed without accessing a root complex of the PCIe interconnect.

9. The method of claim 1, wherein filtering granularity is substantially greater than 4 KB.

10. The method of claim 1, further comprising updating the address filters associated with the i^{th} isolation group to reflect device changes in the i^{th} isolation group, whereby consistency is maintained between the address filters and the isolation groups.

11. A computer comprising:
an interconnect;
a plurality of I/O devices connected to the interconnect;
a memory having computer readable instructions; and
a processor set, connected to the interconnect, for executing the computer readable instructions to configure the computer to set up address validation for peer-to-peer communication between the I/O devices, comprising:
identifying a number of isolation groups within a virtual partitioning of an address space across the plurality of I/O devices; and
storing address filters at locations associated with the plurality of I/O devices;
wherein:
an address filter associated with an I/O device of a given isolation group includes identifications and address ranges of other I/O devices of the given isolation group so that the I/O devices of the given isolation group are authorized to read and write on peer address space.

12. The computer of claim 11, wherein the address filters are stored in their associated I/O devices.

13. The computer of claim 12, wherein each I/O device includes a core configured to use its associated address filter to perform address validation to prevent unauthorized access upon receipt of a DMA request, including:
making a determination as to whether a remote address in the DMA request matches an entry in the associated address filter;
dropping the DMA request if there is no match; and
issuing the DMA request if there is a match.

14. The computer of claim 11, wherein:
the interconnect includes a switch;
at least some of the I/O devices are connected to ports of the switch; and
the address filters are stored in the ports of the switch to which their associated I/O devices are connected.

15. The computer of claim 14, wherein the switch includes a controller configured to perform address validation to prevent unauthorized access upon receipt of a DMA request, including:
accessing the address filter from the port to which a destination I/O device is connected;
using the accessed address filter to make a determination as to whether an ID and remote address in the DMA request matches an entry in the accessed address filter;
dropping the DMA request if there is no match; and
issuing the DMA request if there is a match.

16. The computer of claim 11, further comprising an input/output memory management unit (IOMMU); wherein identifying the number of isolation groups includes examining the IOMMU.

17. The computer of claim 11, wherein the interconnect is PCIe interconnect, and wherein the address validation is performed without accessing a root complex of the PCIe interconnect.

18. A computer program product comprising one or more computer-readable memory devices encoded with data including instructions that, when executed, causes a processor set to perform an address validation method for peer-to-peer communication between a plurality of I/O devices connected to a computer interconnect, the method comprising:
identifying a number of isolation groups within a virtual partitioning of an address space across the plurality of I/O devices; and
storing address filters associated with the plurality of I/O devices;
wherein an address filter associated with an I/O device of a given isolation group includes identifications and address ranges of any other I/O devices of the given isolation group so that no I/O devices outside of the given isolation group are authorized to perform DMA operations on peer address space of the given isolation group.

19. The computer program product of claim 18, wherein the address filters are stored in their associated I/O devices.

20. The computer program product of claim 18, wherein:
the computer interconnect includes a switch;
the I/O devices are connected to ports of the switch; and
the address filters are stored in the ports of the switch to which their associated I/O devices are connected.
